(19) United States
(12) Patent Application Publication
(10) Pub. No.: US 2026/0174622 A1
(43) Pub. Date: Jun. 25, 2026

(54) MASSAGE DEVICE

(71) Applicant: Amoreo Europe S.L., Valencia (ES)

(72) Inventor: Tenghui Huang, Dongguan (CN)

(21) Appl. No.: 19/430,308

(22) Filed: Dec. 23, 2025

(30) Foreign Application Priority Data
Dec. 23, 2024 (CN) 202411908326.4

(51) Int. Cl. A61H 19/00; A61H 23/02

(52) U.S. Cl. CPC A61H 19/44; A61H 23/0254; A61H 2201/1215; A61H 2201/1418; A61H 2201/149; A61H 2201/1664

(57) ABSTRACT

A massage device includes a main body, and first and second massage portions extending from the main body. The first massage portion is configured to be inserted into a cavity of a human body, and the second massage portion is configured to contact a part of the human body adjacent to the cavity. The second massage portion is movable relative to the first massage portion between a first position and a second position, so that the second massage portion is always in contact with the part of the human body when the first massage portion moves in the cavity during use.

### CROSS-REFERENCE TO RELATED APPLICATIONS

This application claims priority of Chinese Patent Application No. 202411908326.4, filed on Dec. 23, 2024, the entire contents of which are hereby incorporated by reference.

### TECHNICAL FIELD

The present application relates to the technical field of adult products, and in particular to a massage device.

### BACKGROUND

In recent years, various adult products have been developed to help users enhance their sexual experience. Conventional adult products, such as love eggs, are generally mechanical vibration devices. These devices provide high-frequency vibrations to stimulate sensitive parts of the human body, such as the vagina, the penis, and etc., which cause strong discomfort and result in poor user experience.

### SUMMARY

An object of the present application is to provide a massage device which can provide better stimulation effect.

In order to achieve the above object, an embodiment of the present application provides a massage device, including a main body, and first and second massage portions extending from the main body, the first massage portion being configured to be inserted into a cavity of a human body, and the second massage portion being configured to contact a part of the human body adjacent to the cavity; wherein the second massage portion is movable relative to the first massage portion between a first position and a second position, so that the second massage portion is always in contact with the part of the human body when the first massage portion moves in the cavity during use.

For the present massage device, the first and second massage portions generate stimulations to different sensitive areas of the human body in different manners, providing a more comfortable sexual experience, and thus the users are more likely to reach orgasm with the help of the present massage device.

### BRIEF DESCRIPTION OF THE DRAWINGS

In order to illustrate the technical solution in embodiments of the present application more clearly, the following briefly introduces accompanying drawings used in the description of the embodiments. Obviously, the accompanying drawings in the following description are only some embodiments of the present application. Those of ordinary skill in the art can obtain other accompanying drawings from these accompanying drawings without any creative efforts.

FIG. 1 is an isometric, assembled view of a massage device according to an embodiment of the present application.

FIG. 2 is a side view of the massage device of FIG. 1.

FIG. 3 is a top vide of the massage device of FIG. 1.

FIG. 4 is a cross sectional view of the massage device taken along line IV-IV of FIG. 3.

FIG. 5 is a schematic view of the massage device of FIG. 1 during use.

FIG. 6 is a cross-sectional view of the massage device of FIG. 5.

FIG. 7 is an exploded view of the massage device of FIG. 1, wherein an outer layer is removed to clearly show internal components.

FIG. 8 is a schematic view of a sliding module of the massage device of FIG. 7.

FIG. 9 shows the sliding module of FIG. 8 from another aspect.

FIG. 10 is an exploded view of the sliding module of FIG. 8.

FIG. 11 is a schematic view of a driving module of the massage device of FIG. 7.

FIG. 12 is an exploded view of the driving module of FIG. 11.

FIG. 13 is an isometric, assembled view of a massage device according to another embodiment of the present application.

FIG. 14 is a cross sectional view of the massage device of FIG. 13 in a first state.

FIG. 15 is a cross sectional view of the massage device of FIG. 13 in a second state.

### DESCRIPTION OF THE EMBODIMENTS

In order to make those skilled in the art better understand the technical solution of the present application, the technical solution in the embodiments of the present application will be clearly and completely described below with reference to accompanying drawings in the embodiments of the present application. Obviously, the described embodiments are only a part of the embodiments of the present application, but not all of the embodiments. Based on the embodiments of the present application, all other embodiments obtained by those skilled in the art without any creative efforts fall within the protection scope of the present application.

It should be noted that when an element is said to be “connected” to another element, it may be directly connected to another element, or indirectly connected to another element through one or multiple intermediate elements.

In the specification, the oriental or positional relationships indicated by the terms “longitudinal”, “transverse”, “top”, “bottom”, “inner”, “outer”, “central”, “axial”, “radial”, “circumferential” and the like are only intended to facilitate the description of the present application and simplify the description based on oriental or positional relationships shown in the accompanying drawings, not to indicate or imply that the apparatus or element referred must have a specific orientation, is constructed and operated in a specific orientation, and therefore cannot be understood as a limitation of the present application.

Unless otherwise specified and limited, the specific meanings of all technical and scientific terms used in the specification can be specifically understood by persons of ordinary skill in the art. The terms used in the specification of this application is for the purpose of describing specific embodiments only and is not intended to limit this application.

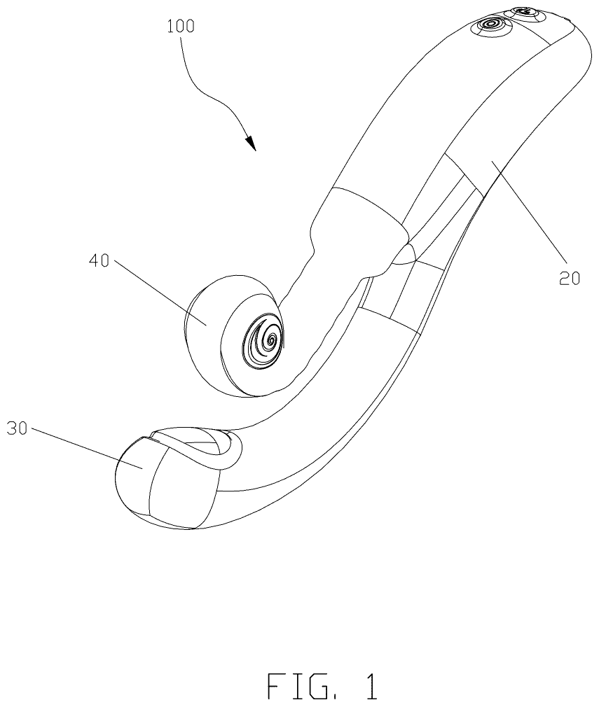

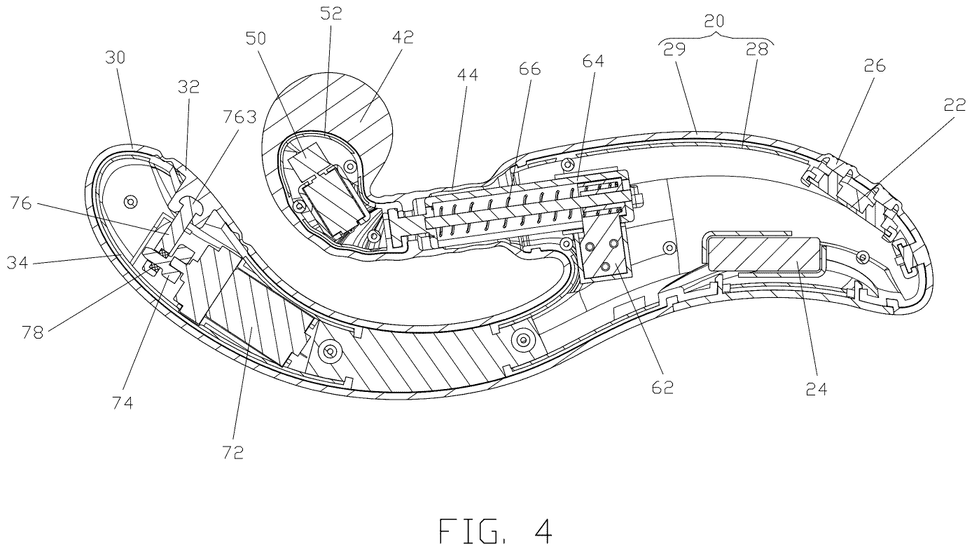

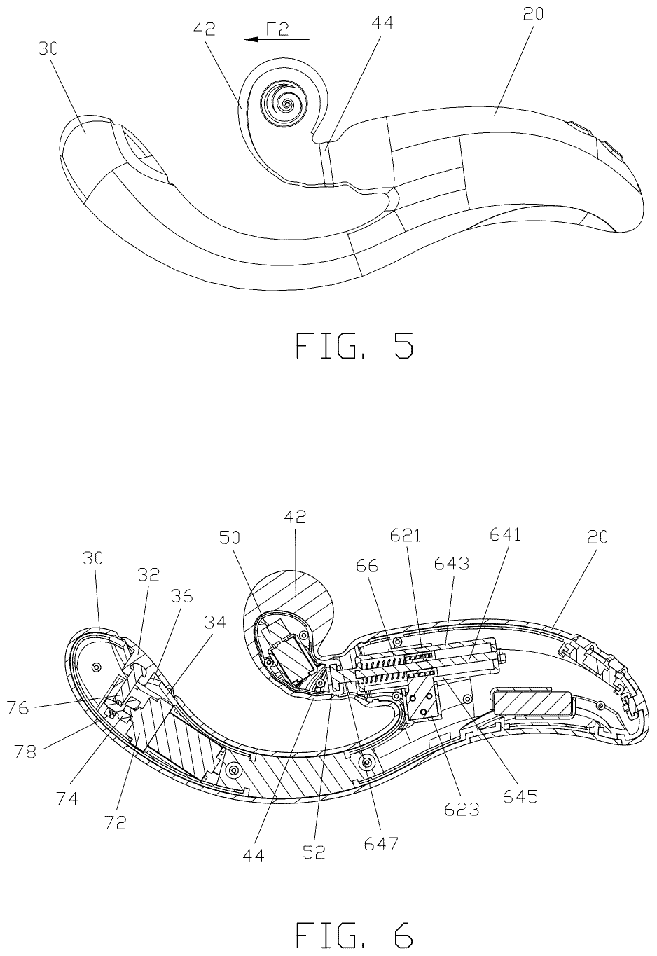

Referring to FIGS. 1-6, a massage device 100 according an embodiment of the present application is shown. This massage device 100 includes a main body 20, and first and second massage portions 30, 40 extending outwardly from the main body 20. The first massage portion 30 is configured to be inserted into a cavity of a human body, and the second massage portion 40 is configured for contacting a part of the human body adjacent to the cavity. Thus, the present massage device 100 is capable of stimulating two different parts of the human body simultaneously.

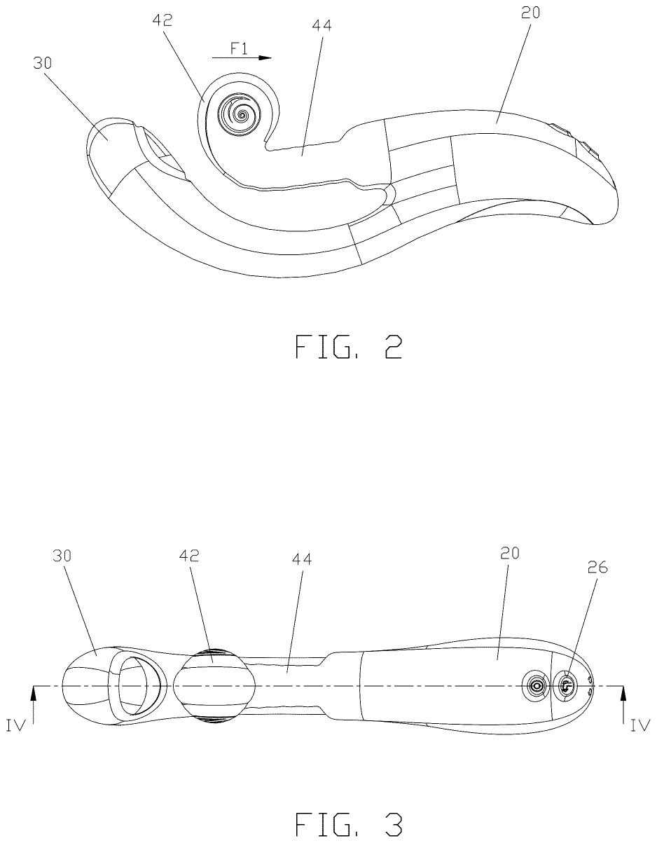

The second massage portion 40 is movable relative to the first massage portion 30, so that the massage device 100 has at least two different states. In a first state, as shown in FIG. 2 to FIG. 4, a distal end of the second massage portion 40 is at a first position, being close to a distal end of the first massage portion 30. In a second state, as shown in FIGS. 5-6, the distal end of the second massage portion 40 is at a second position, which is away from the distal end of the first massage portion 30 compared to the first position.

Preferably, the first massage portion 30 and the second massage portion 40 are made of flexible materials, such as silicone, with a soft texture and comfortable touch.

As shown in FIGS. 1-2, the first massage portion 30 is elongated and curved, configured for simulating the male penis. The second massage portion 40 is located above and spaced from the first massage portion 30. Preferably, the first massage portion 30 is longer than the second massage portion 40, and thus the distal end of the first massage portion 30 is further away from the main body 20 relative to the distal end of the second massage portion 40.

As shown in FIG. 4, a first vibration member 50, such as a vibration motor is set in the second massage portion 40. The first vibration member 50 is used for generating vibration to stimulate the part of the human body in contact with the second massage portion 40. Preferably, the distal end of the second massage portion 40 is configured as a spherical-shaped distal portion 42, and the first vibration member 50 is accommodated inside the distal portion 42.

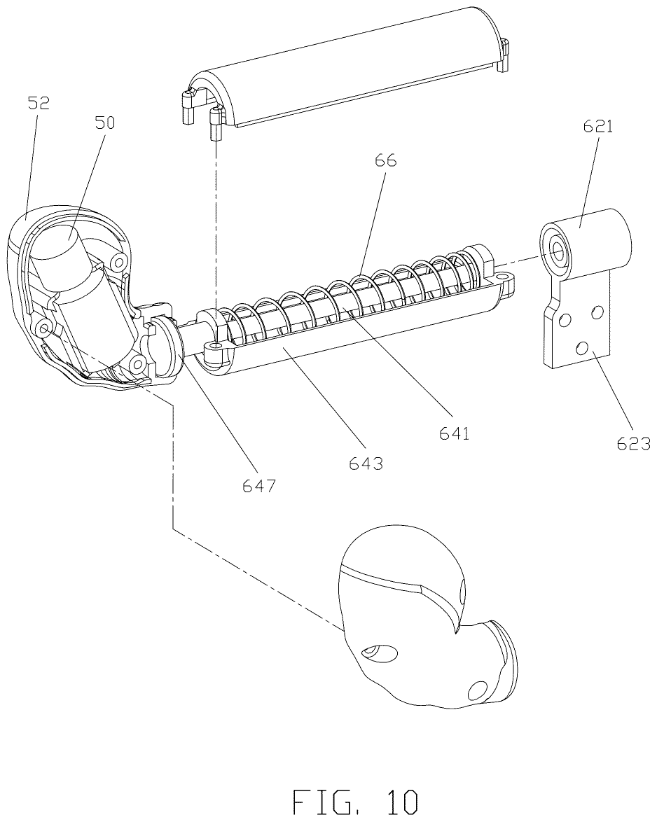

In this embodiment, referring also to FIG. 10, a support frame 52 is set inside the distal portion 42 of the second massage portion 40, and the first vibration member 50 is accommodated inside the support frame 52. Preferably, the support frame 52 is made of hard materials, such as plastic, metal, and etc., with a hardness greater than that of the second massage portion 40. For facilitating assembly of the first vibration member 50, the support frame 52 is preferably composed of two separate parts, and the second massage portion 40 may be integrally formed around the support frame 40 through overmolding.

Such massage device 100 is preferably suitable for female, wherein the first massage portion 30 can be inserted into the vagina of the human body, and the second massage portion 40 can be in contact with the clitoris. During use, the first massage portion 30 repeatedly enters and exits the vagina of the human body, rubbing against the vagina wall to produce a stimulating effect, while the second massage portion 40 directly stimulates the clitoris, allowing female users to quickly reach orgasm and thus greatly improving the user experience.

It should be noted that the present massage device 100 is also suitable for male. For example, the first massage portion 30 may be inserted into the rectum, and the second massage portion 40 may maintain contact with the scrotum. By stimulating the prostate with the first massage portion 30 and the scrotum with the second massage portion 40, allowing female users to ejaculate quickly.

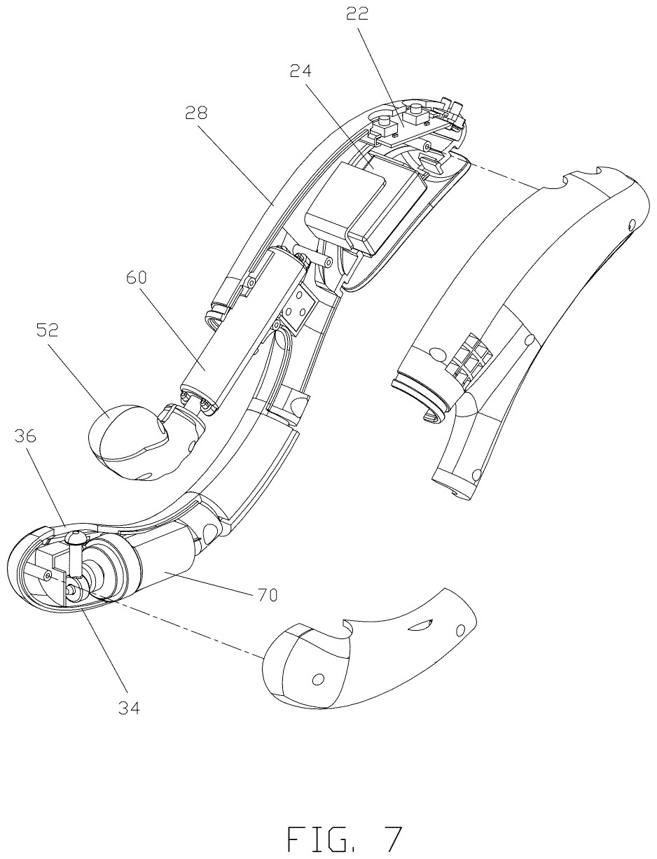

During use, the reciprocating movement of the first massage portion 30 in the cavity of the human body makes the second massage portion 40 have a tendency to separate from the part of human body (such as the clitoris) in contact with it. Referring to FIG. 4 and FIG. 7, a sliding module 60 is provided inside the massage device 100 for maintaining the distal portion 42 of the second massage portion 40 in contact with the part of the human body during the reciprocating movement of the first massage portion 30 in the cavity.

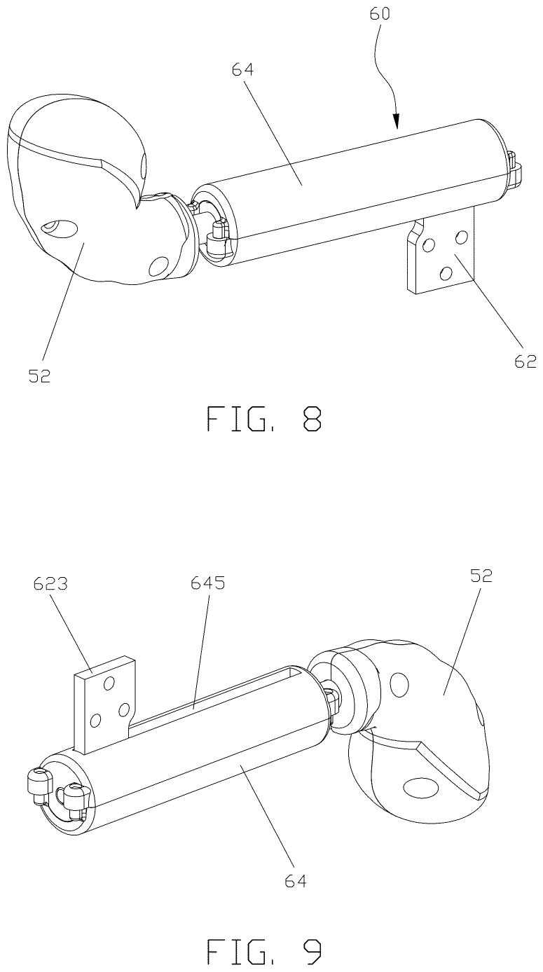

Referring also to FIGS. 8-10, the sliding module 60 includes a fixing member 62 connected to the main body 20, a moving member 64 connected to the second massage portion 40, and an elastic member 66 provided between the fixing member 62 and the moving member 64. By means of relative movement of the moving member 64 and the fixing member 62, the second massage portion 40 can move relative to the main body 20 to change its position relative to the first massage portion 30. In this way, during the reciprocating movement of the first massage portion 30, the position of the second massage portion 40 relative to the human body can remain unchanged.

As shown in FIGS. 1-4, when the massage device 100 is in the first state, the distal portion 42 of the second massage portion 40 is not subjected to an external force, and the elastic member 66 extends naturally or is compressed slightly.

As shown in FIGS. 5-6, when the first massage portion 30 is inserted into the cavity of the human body, the distal portion 42 of the second massage portion 40 is subjected to force from the part of the human body in contact with it, causing the second massage portion 40 and the moving member 64 to move relative to the fixing member 62 in a first direction F1 (such as rightwards, as indicated by the arrow in FIG. 2), the massage device 100 thus changes to the second state.

In the second state, the elastic member 66 is compressed and deformed, and the distal portion 42 of the second massage portion 40 is away from the distal end of the first massage portion 30.

When the first massage portion 30 is pulled out from the cavity of the human body, the force on the distal portion 42 of the second massage portion 40 from the part of the human body in contact with it decreases, and thus the elastic member 66 recovers to push the moving member 64 and the second massage portion 40 to move in a second direction F2 (such as leftwards, as indicated by the arrow in FIG. 5) that is opposite to the first direction F1. Finally, the moving member 64 and the second massage portion 40 returns to their original positions, and the massage device 100 returns to the first state.

Referring to FIG. 2, the second massage portion 40 further includes a telescopic portion 44 connected between the main body 20 and the distal portion 42. The telescopic portion 44 is configured as a corrugated tube with multiple wrinkles, and due to the movement of the moving member 64, certain deformation is generated in the telescopic portion 44. A length of the telescopic portion 44 thus changes according to the movement of the moving member 64, making the distal portion 42 move between the first position and the second position.

Referring to FIG. 10, the moving member 64 includes a sliding rod 641 extending along the first/second direction, and the fixing member 62 includes a mounting tube 621 slidably mounted around the sliding rod 641. By means of the cooperation of the mounting tube 621 and the sliding rod 641, the movement of the moving member 64 relative to the fixing member 62 is smooth and stable.

In this embodiment, the moving member 64 further includes a sliding sleeve 643 mounted around and fixed to the sliding rod 641. A radial space is formed between the sliding rod 641 and the sliding sleeve 643 for accommodating the elastic member 66 therein. For facilitating assembly of the elastic member 66 and the fixing member 62, the sliding sleeve 643 is preferably composed of two separate parts.

The elastic member 66 is preferably a coil spring, received in the sliding sleeve 643 and mounted around the sliding rod 641, wherein one end of the elastic member 66 is fixed to the sliding sleeve 643 and the other end is fixed into the mounting tube 621. During use, the sliding sleeve 643 and the sliding rod 641 move together relative to the mounting tube 621 to make the elastic member 66 deform.

Referring to FIG. 6 and FIG. 10, the fixing member 62 is accommodated inside the main body 20, and a connecting portion 623 extends radially and outwardly from the mounting tube 621 to fixedly connect the main body 20. Correspondingly, an elongated groove 645 is defined in the sliding sleeve 643 for extending of the connecting portion 623 therethrough and facilitates the relative movement of the moving member 64 and the fixing member 62.

As shown in FIG. 4, in the first state, the moving member 64, including the sliding rod 641 and the sliding sleeve 643, is partly received in the main body 20 and partly received in the telescopic portion 44 of the second massage portion 40.

When the massage device 100 switches from the first state to the second state, as shown in FIG. 6, due to the distal portion 42 of the second massage portion 40 moving towards the main body 20 in the first direction, the telescopic portion 44 shrinks and becomes shorter, and almost all of the sliding sleeve 643 and sliding rod 641 move into the main body 20.

Conversely, when the massage device 100 switches from the second state to the first state, the elastic member 66 recovers to push the moving member 64 moves away from the main body 20 in the second direction, causing the telescopic portion 44 to stretch and elongate, thereby pushing the distal portion 42 of the second massage portion 40 back to the first position. The wrinkles improve the elasticity of the telescopic portion 44, allowing it to adapt to the movement of the moving member 64. In this way, even if the first massage portion 30 moves significantly, the second massage portion 40 remains in contact with the part of the human body to provide additional stimulation.

In this embodiment, as shown in FIG. 6 and FIG. 10, a protrusion 647 extends from an end of the sliding sleeve 643 to fixedly connect the support frame 52, thereby the second massage portion 40 and the moving member 64 can move together. Preferably, the fixing member 62 and the moving member 64 are made of hard materials, such as plastic, metal, and etc., which enable efficient power transmission between the moving member 64 and the support frame 52.

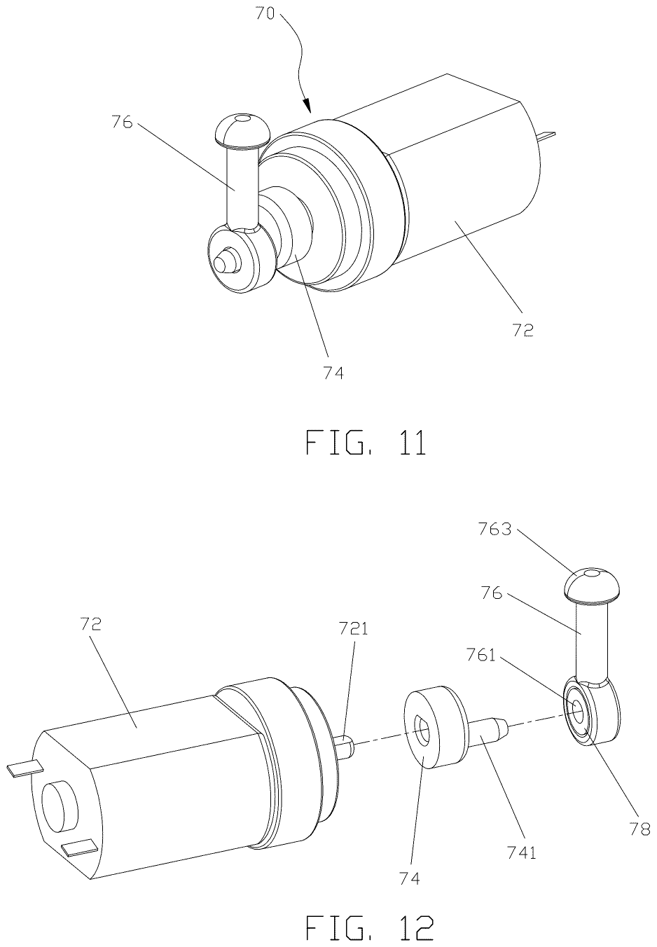

In this embodiment, as shown in FIG. 7, the massage device 100 further includes a driving module 70 set inside the first massage portion 30. Preferably, the first massage portion 30 has a vibrating diaphragm 32 located adjacent to its distal end and corresponding to the driving module 70. Referring to FIGS. 11-12, the driving module 70 includes a driving motor 72 with an output shaft 721, an eccentric wheel 74 connected to the output shaft 721, and a driving rod 76.

The eccentric wheel 74 has a transmission rod 741 that deviates from a rotary axis of the eccentric wheel 74. One end of the driving rod 76 defines a mounting hole 761, and the transmission rod 741 is rotatably inserted in the mounting hole 761. Preferably, a bearing 78 is provided in the mounting hole 761 to support rotation of the transmission rod 741 relative to the driving rod 76. A driving head 763 is formed at the other end of the driving rod 76 and has an enlarged outer diameter. The driving head 763 is embedded into a central portion of the vibrating diaphragm 32 of the first massage portion 30.

During operation, rotation of the driving motor 72 is converted into revolving of the driving rod 76 about the rotary axis, and then converted into reciprocating movement of the driving rod 76 and the corresponding vibrating diaphragm 32 of the first massage portion 30 in the axial direction of the driving rod 76, so as to slap a cavity wall of the human body nestled to the vibrating diaphragm 32 of the first massage portion 30. Preferably, the vibrating diaphragm 32 is provided at a side of the first massage portion 30 facing towards the second massage portion 40.

In this embodiment, a support shell 34 is provided inside the first massage portion 30 for accommodating the driving module 70 therein. A through hole 36 is defined in the support shell 34 at a position corresponding to the driving rod 76 for extending of the enlarged head 763 of the driving rod 76 therethrough to connect the vibrating diaphragm 32 of the first massage portion 30. Preferably, the support shell 34 is made of hard materials, such as plastic, metal, and etc.

In this embodiment, a control circuit board 22 is provided inside the main body 20 for controlling the operation of the massage device 100, such as controlling a vibration frequency of the first vibration member 50, controlling a rotary speed and/or direction of the driving motor 72, and etc. A battery 24, preferably a rechargeable battery, is provided inside the main body 20 and connected to the circuit board 22 for supplying electric power to the motors 50, 72. Further, control buttons 26 may be provided on the main body 20 for input the user's instructions.

In this embodiment, as shown in FIG. 4, the main body 20 includes an inner layer 28 and an outer layer 29 encapsulating the inner layer 28, wherein the outer layer 29 is made of flexible materials, such as silicone; and the inner layer 28 is made of hard materials, such as plastic, metal, and etc. Preferably, the outer layer 29, the first massage portion 30 and the second massage portion 40 are integrally formed as one piece, which achieves good sealing effect for the components inside the massage device 100, and facilitates the cleaning and storage of the massage device 100.

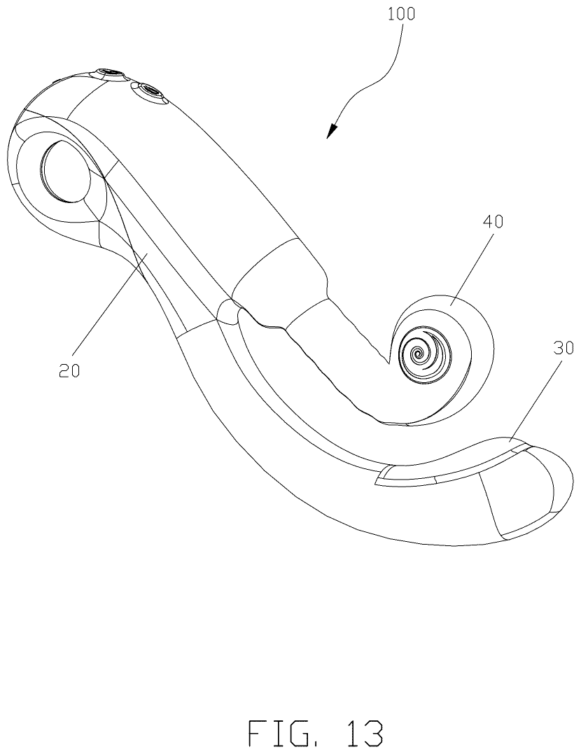

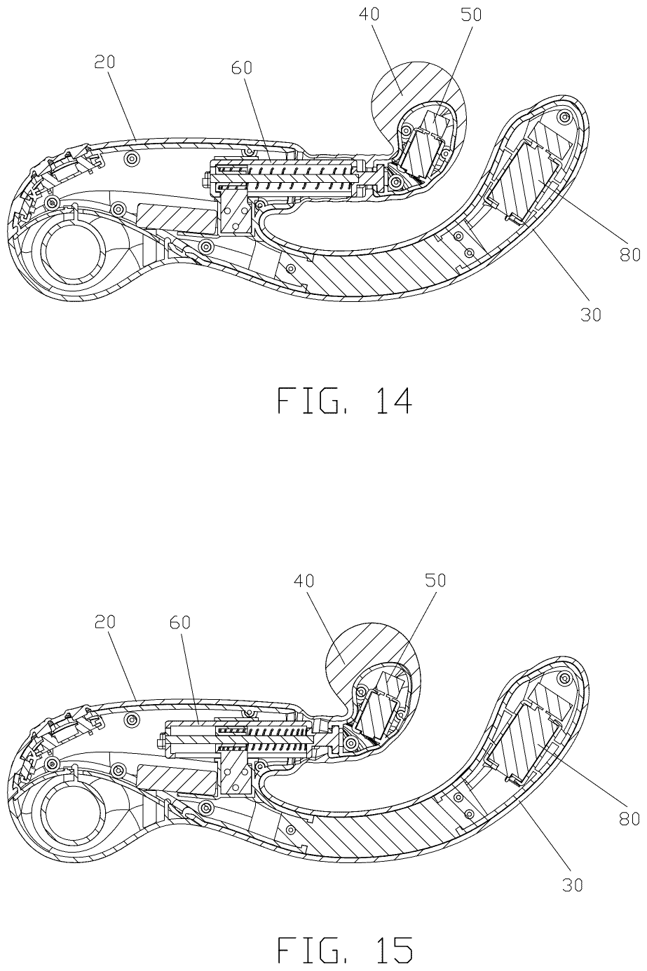

Referring to FIGS. 13-15, a massage device 100 according to an alternative embodiment of the present application is shown. This massage device 100 includes a main body 20, and first and second massage portions 30, 40 extending from the main body 20. A first vibration member 50 is set in the second massage portion 40. Differently, in this embodiment, a second vibration member 80 is provided inside a distal end of the first massage portion 30 instead of the driving module 60 of the previous embodiment.

During use, the first massage portion 30 repeatedly enters and exits the cavity of the human body, rubbing against the cavity wall to produce a stimulating effect, while the second vibration member 80 inside the first massage portion 30 provides a vibration to enhance the stimulating effect of the first massage portion 30. At the same time, the second massage portion 40 contacts a part of the human body adjacent to the cavity, and the first vibration member 50 inside the second massage portion 40 provides a vibration to stimulate of the part of the human body adjacent to the cavity.

Similar to the previous embodiment, a sliding module 60 is provided inside the massage device 100 for maintaining the second massage portion 40 always in contact with the part of the human body. Details for the sliding module 60 may refer to the previous embodiment and will not be elaborated here.

For the present massage device 100, the first and second massage portions 30, 40 generate stimulations to different sensitive areas of the human body in different manners, providing a more comfortable sexual experience, and thus the users are more likely to reach orgasm with the help of the present massage device 100. It should be understood that, during use, the first vibration member 50, the second vibration member 80/the driving module 70 of the massage device 100 may be started separately or simultaneously as needed.

Finally, it should be noted that: the above merely describes preferred embodiments of the present application without intention to limit the scope of the present application. Although the present application has been described in detail with reference to the foregoing embodiments, for those skilled in the art, the technical solutions described in the foregoing embodiments can still be modified, or some of the technical features can be equally replaced. Any modifications, equivalent replacements, improvements, and etc. made within the spirit and principle of the present application should be within the scope of the present application.

1. A massage device comprising a main body, and first and second massage portions extending from the main body, the first massage portion being configured to be inserted into a cavity of a human body, and the second massage portion being configured to contact a part of the human body adjacent to the cavity;
wherein the second massage portion is movable relative to the first massage portion between a first position and a second position, so that the second massage portion is always in contact with the part of the human body when the first massage portion moves in the cavity during use.

2. The massage device according to claim 1, wherein a first vibration motor is set in the second massage portion.

3. The massage device according to claim 2, wherein the second massage portion comprises a spherical-shaped distal portion, and the first vibration member is set in the spherical-shaped distal portion.

4. The massage device according to claim 3, wherein the second massage portion further comprises a telescopic portion connected between the spherical-shaped distal portion and the main body, and a length of the telescopic portion varies with the movement of the second massage portion between the first position and the second position.

5. The massage device according to claim 4, wherein the telescopic portion is configured as a corrugated tube with multiple wrinkles.

6. The massage device according to claim 1, wherein an elastic member is provided inside the massage device and connected to the second massage portion in a transmission manner:
when the first massage portion moves into the cavity, the second massage portion moves from the first position to the second position and makes the elastic member deform; and
when the first massage portion moves outside the cavity, the elastic member recovers to push the second massage portion to move from the second position to the first position.

7. The massage device according to claim 6, further comprising a fixing member connected to the main body and a moving member connected to the second massage portion, wherein moving member is in sliding fit with the fixing member, and the elastic member is provided between the fixing member and the moving member.

8. The massage device according to claim 7, wherein the moving member comprises a sliding rod and a sliding sleeve mounted around the sliding rod; and the fixing member comprises a mounting tube received in the mounting sleeve and slidably mounted around the sliding rod.

9. The massage device according to claim 8, wherein the elastic member is received in the mounting sleeve and slidably mounted around the sliding rod, one end of the elastic member is fixed to the mounting tube, and another end of the elastic member is fixed to the sliding sleeve.

10. The massage device according to claim 8, wherein the fixing member further comprises a connecting portion extends from the mounting tube to connect the main body fixedly, and the mounting sleeve defines an elongated sleeve for extending of the connecting portion therethrough.

11. The massage device according to claim 8, wherein a support frame is set in the second massage portion, and a protrusion extends from the sliding sleeve and connects to the support frame fixedly.

12. The massage device according to claim 1, wherein a second vibration motor is set inside the first massage portion.

13. The massage device according to claim 1, wherein a driving module is set inside the first massage portion, and the first massage portion has a vibrating diaphragm connected to the driving module.

14. The massage device according to claim 13, wherein the vibrating diaphragm is formed at a side of the first massage portion facing towards the second massage portion.

15. The massage device according to claim 13, wherein the driving module comprises a driving motor, an eccentric wheel connected to the driving motor, and a driving rod; a transmission rod is formed on the eccentric wheel and deviates from a rotary axis of the eccentric wheel, one end of the driving rod is rotatably mounted around the transmission rod, and another end of the driving rod is embedded into the vibrating diaphragm.

16. The massage device according to claim 1, wherein the first massage portion is longer than the second massage portion, and a distal end of the first massage portion is further away from the main body relative to a distal end of the second massage portion.

17. A massage device comprising a main body, and first and second massage portions extending from the main body, the first massage portion being configured to be inserted into a cavity of a human body, and the second massage portion being configured to contact a part of the human body adjacent to the cavity;
wherein an elastic member is provided inside the massage device and connected to the second massage portion in a transmission manner,
when an external force is applied to a distal end of the second massage portion to move it from a first position to a second position, the elastic member deforms; and
when the external force decreases or disappears, the elastic member recovers and pushes the second massage portion back from the second position to the first position, wherein the first position is far away from the main body relative to the second position.

18. The massage device according to claim 17, wherein the first massage portion is configured to be inserted into a vagina of a human body, and the second massage portion is configured to contact a clitoris of the human body.

19. The massage device according to claim 17, wherein the distal end of the second massage portion is spherical-shaped, and a vibration motor is set inside the distal end of the second massage portion.

20. The massage device according to claim 19, wherein the second massage portion further comprises a telescopic portion with a length varying with the movement of the second massage portion between the first position and the second position.
